(19) United States
(12) Patent Application Publication
(10) Pub. No.: US 2014/0320570 A1
(43) Pub. Date: Oct. 30, 2014

(54) LIQUID CONTAINER AND INKJET IMAGE FORMING APPARATUS

(71) Applicant: KYOCERA Document Solutions Inc., Osaka (JP)

(72) Inventor: Susumu HIROSHIMA, Osaka (JP)

(73) Assignee: KYOCERA Document Solutions Inc., Osaka (JP)

(21) Appl. No.: 14/254,308

(22) Filed: Apr. 16, 2014

(30) Foreign Application Priority Data
Apr. 26, 2013 (JP) 2013-094142

(51) Int. Cl. B41J 2/175

(52) U.S. Cl. CPC B41J 2/17503
USPC 347/86

(57) ABSTRACT

A liquid container includes a container main body and a supplying member. The container main body is formed in a bag shape by arranging a gusset part expandably/contractably in upward and downward directions between an upper face part and a lower face part. The supplying member is arranged at one end side of the upper face part and lower face part. On at least any one of inner faces of the upper face part and lower face part, a first groove part is formed to extend from another end side at an opposite side of the one end side to the one end side.

### INCORPORATION BY REFERENCE

This application is based on and claims the benefit of priority from Japanese Patent application No. 2013-094142 filed on Apr. 26, 2013, the entire contents of which are incorporated herein by reference.

### BACKGROUND

The present disclosure relates to a liquid container and an inkjet image forming apparatus including the liquid container.

An inkjet image forming apparatus forms an image on a surface of a sheet by ejecting an ink from a recording head to the sheet. The ink ejected from the recording head to the sheet is supplied from an ink container to the recording head. The ink container is configured to contain a liquid container, such an ink pack filled with the ink, in a container. The ink pack is configured to be formed in a bag shape with a gusset by a flexible film material, thereby expanding when the ink is filled, and contracting when the ink is used and reduced.

As one example, a liquid containing body is formed in a bag shape by a pair of side face parts and a pair of gusset parts put between the pair of the side face parts. The liquid containing body has a containing bag configured so that, when a liquid contained inside the containing bag is flowed out, the pair of the gusset parts are folded and inserted between the pair of the side face parts, and then, volume of the containing bag is reduced.

As another example, an ink cartridge for a recording device has a bag-like ink pack filled with an ink inside and formed in a flat-like shape by a flexible material. In the ink pack, a close-contact prevention member is installed to prevent both inner faces of the ink pack from closely contacting to each other in accordance with reduction of the ink containing amount and to provide an ink path.

However, in the liquid containing body of the above-mentioned one example, since the gusset parts expanding and contracting in left and right directions are arranged in an upper face and a lower face, when the ink is ejected, the contraction of the gusset part of the lower face is disturbed due to weight of the ink not yet ejected from the liquid containing body. Because the gusset part cannot be contracted, much ink cannot be ejected and is remained in the liquid containing body.

In addition, since the ink in the vicinity of an outflow port in the liquid containing body is easily ejected, a part at the outflow port's side of the gusset parts are easily folded. Accordingly, when the ink is used, at first, the inner faces at the outflow port's side in the liquid containing body are closely contacted and closed. Thus, when the inner faces at the outflow port's side are closed, because the ink contained at an opposite side to the outflow port in the liquid containing body is difficulty ejected, much ink at the opposite side cannot be ejected and is remained. There is an impossibility of avoiding such a closing of the inner faces in the liquid containing body, even if the direction of the liquid containing body are changed and the gusset part is located at another position expect for the lower face.

Moreover, in the ink pack of the above-mentioned other example, since the close-contact prevention member is arranged inside, deformation of the container is disturbed by the close-contact prevention member. Therefore, in the container, such as the ink pack having the gusset part, configured to deform greatly and to obtain a large capacity, if the close-contact prevention member disturbing the deformation is applied, there is an impossibility of obtain desired volume. Incidentally, if the close-contact prevention member is arranged at the gusset part's side for the purpose of preventing the disturbance of the deformation, since the fold of the gusset part is disturbed by a space of the close-contact prevention member, the gusset part is insufficiently folded and the close-contact of the inner faces expect for the gusset part cannot be prevented. Moreover, because the close-contact prevention member is added, material cost and manufacturing cost are increased and man-hour for manufacturing and attaching the close-contact prevention member is increased. Furthermore, by gluing the close-contact prevention member inside the ink pack, there are possibilities of causing risks that foreign matter gets mixed in the ink pack and quality of the ink is changed.

### SUMMARY

In accordance with an embodiment of the present disclosure, a liquid container includes a container main body and a supplying member. The container main body is formed in a bag shape by arranging a gusset part expandably/contractably in upward and downward directions between an upper face part and a lower face part. The supplying member is arranged at one end side of the upper face part and lower face part. On at least any one of inner faces of the upper face part and lower face part, a first groove part is formed to extend from another end side at an opposite side of the one end side to the one end side.

Furthermore, in accordance with an embodiment of the present disclosure, an inkjet image forming apparatus includes a liquid container. The liquid container includes a container main body and a supplying member. The container main body is formed in a bag shape by arranging a gusset part expandably/contractably in upward and downward directions between an upper face part and a lower face part. The supplying member is arranged at one end side of the upper face part and lower face part. On at least any one of inner faces of the upper face part and lower face part, a first groove part is formed to extend from another end side at an opposite side of the one end side to the one end side.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a schematic diagram schematically showing a printer according to an embodiment of the present disclosure.

FIG. 2 is a sectional view schematically showing the printer according to the embodiment of the present disclosure.

FIG. 3 is a perspective view showing the printer in a state, where an installation cover of a container installed part is opened, according to the embodiment of the present disclosure.

FIG. 4 is a front perspective view showing an ink container applied to the printer according to the embodiment of the present disclosure.

FIG. 5 is a rear perspective view showing the ink container applied to the printer according to the embodiment of the present disclosure.

FIG. 6 is a perspective view showing the ink container in a state, where a container is detached, applied to the printer according to the embodiment according to the present disclosure.

FIG. 7 is a perspective view showing the ink container in a state, where a spout cover is detached, applied to the printer according to the embodiment according to the present disclosure.

FIG. 8 is perspective view showing an ink pack in an ink emptied state applied to the printer according to the embodiment of the present disclosure.

FIG. 9 is an exploded perspective view showing the ink pack applied to the printer according to the embodiment of the disclosure.

FIG. 10 is a bottom perspective view showing an upper face film of the ink pack applied to the printer according to the embodiment of the present disclosure.

FIG. 11 is a perspective view showing the ink pack in an ink filled state applied to the printer according to the embodiment of the present disclosure.

### DETAILED DESCRIPTION

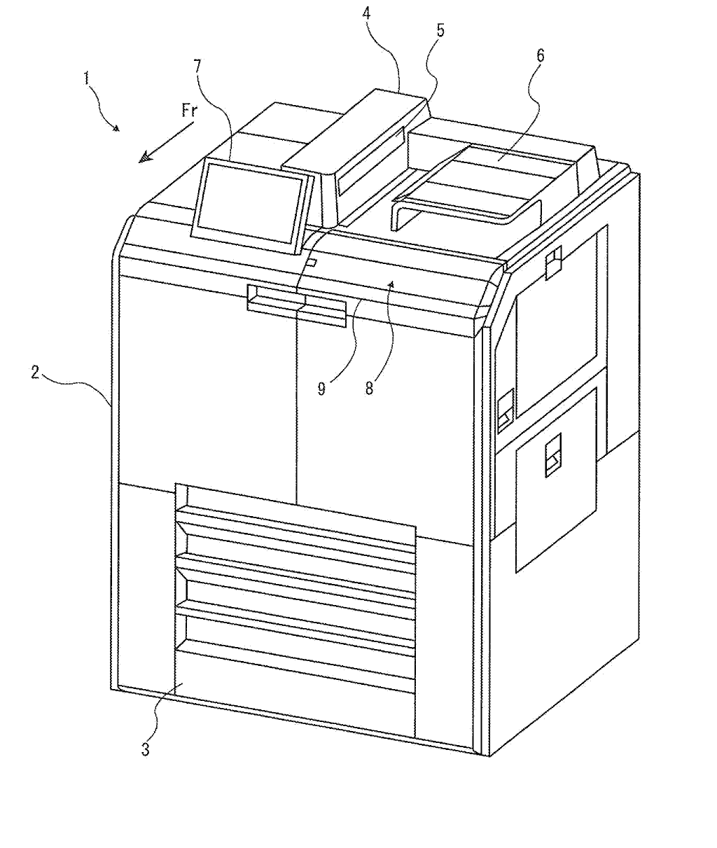

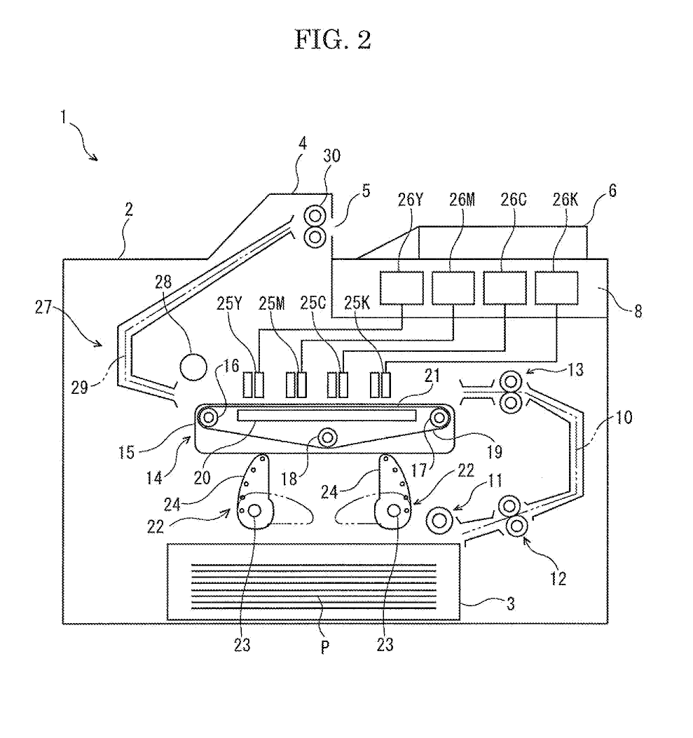

First, with reference to FIGS. 1 to 3, the entire structure of an inkjet color printer 1 (hereinafter, called as a “printer 1”) as an inkjet image forming apparatus will be described. Hereinafter, a near side (a reader's side) of FIGS. 1 and 2 will be described as the front side of the printer 1 and arrows Fr indicate the front side of the printer 1.

As shown in FIGS. 1 and 2, the printer 1 includes a box-formed printer main body 2. In a lower part of the printer main body 2, a sheet feeding cartridge 3 configured to store a sheet P is installed pullably. In FIG. 1, a plurality of sheet feeding cartridges 3 are illustrated, while, in FIG. 2, one sheet feeding cartridge 3 is illustrated and other sheet feeding cartridges 3 are omitted for the sake of convenience of the description.

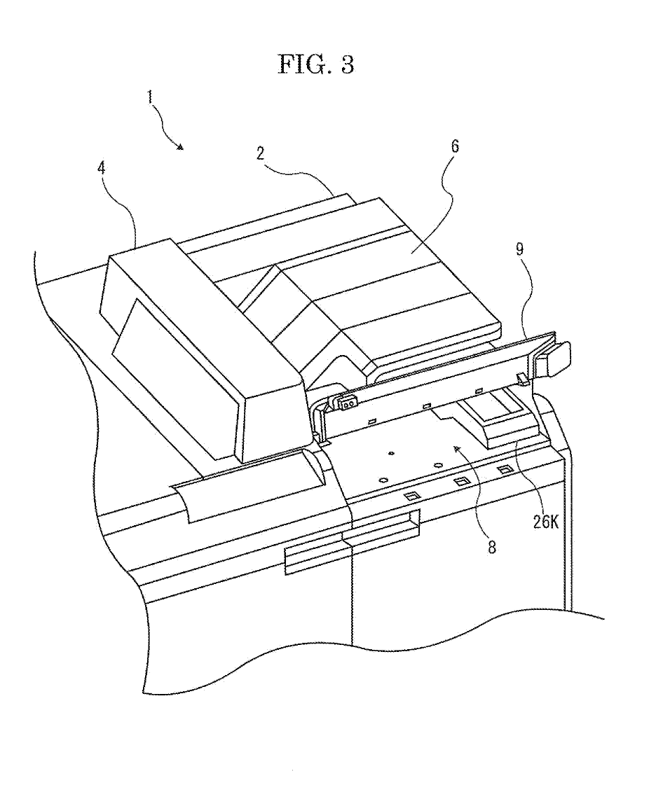

In a top face of the printer main body 2, a protrusion 4 is formed in the vicinity of the center. In a right face of the protrusion 4, an ejecting port 5 ejecting the sheet with a formed image is opened. In the top face of the printer main body 2, an ejected sheet tray 6 receiving the sheet with the formed image is arranged at the right side of the protrusion 4 and a touch panel-type operational panel 7 is attached at the front side of the protrusion 4. FIG. 3 illustrates a state, where the operational panel 7 is detached, for the sake of convenience of the description. Further, in a right upper part of the printer main body 2, a container installed part 8 is arranged. On a front face of the container installed part 8, an installation cover 9 is attached openably/closably.

As shown in FIG. 2, in a right part of the printer main body 2, a conveying path 10 for the sheet P is arranged. At an upstream end of the conveying path 10, a sheet feeding roller 11 is positioned near the sheet feeding cartridge 3 and, at the right side of the sheet feeding roller 11, conveying rollers 12 are positioned. At a downstream end of the conveying path 10, resist rollers 13 are positioned.

In an intermediate part of the printer main body 2, an upward/downward movable conveying unit 14 is attached. The conveying unit 14 includes a conveyance frame 15, a driving roller 16, a following roller 17, a tension roller 18, an endless conveyance belt 19 and an air intake duct 20. The driving roller 16 is rotatably supported at a left upper corner of the conveyance frame 15. The following roller 17 is rotatably supported at a right upper corner of the conveyance frame 15. The tension roller 18 is rotatably supported at a middle lower part of the conveyance frame 15. The conveyance belt 19 is wound around the driving roller 16, following roller 17 and tension roller 18. The air intake duct 20 is located so as to be surrounded by the conveyance belt 19.

In an upper face of the conveyance belt 19, a roughly flat conveyance face 21 is formed. The conveyance belt 19 has a lot of air intake holes (not shown) and a top face of the air intake duct 20 also has a lot of air intake holes (not shown). The air intake duct 20 is connected with a suction device (not shown), such as a suction pomp. Accordingly, by activating the suction device, an air can be sucked via the air intake holes of the conveyance belt 19 and the air intake holes of the air intake duct 20 from a surface side of the conveyance face 21 in the conveyance belt 19 to the air intake duct 20.

In an intermediate lower part of the printer main body 2, a pair of left and right elevating devices 22 is attached below the conveying unit 14. Each elevating device 22 includes a rotation axis 23 and a cam 24 supported by the rotation axis 23. The cam 24 is connected with a driving device (not shown), such as a driving motor. Accordingly, by activating the driving device, each cam 24 is rotated around the rotation axis 23. Each cam 24 is configured so that a posture of the cam 24 is switched between an upright posture (refer to solid line in FIG. 2) and a laid-down posture (refer to two-dot chain line in FIG. 2). The cam 24 is switched to the upright posture to lift up the conveyance frame 15 and to move the conveying unit 14 upward or switched to the laid-down posture to release the lift of the conveyance frame 15 and to move the conveying unit 14 downward.

In the intermediate part of the printer main body 2, four recording heads 25 (25K, 25C, 25M, 25Y) are arranged in parallel above the conveying unit 14. The recording heads 25 correspond to black (K), cyan (C), magenta (M) and yellow (Y) from an upstream side (a right side in the embodiment) in order of a conveying direction of the sheet P. Hereinafter, except for the description to be specified by the colors, the reference characters “K”, “C”, “M” and “Y” with regard to the recording heads 25 are omitted. The recording heads 25 are provided with respective nozzles (not shown) facing to the conveyance face 21 of the conveyance belt 19. The recording heads 25K, 25C, 25M and 25Y are respectively connected to ink containers 26K, 26C, 26M and 26Y corresponding to same ink colors via ink supplying paths.

In the container installed part 8 in the upper part of the printer main body 2, four ink containers 26 (26K, 26C, 26M, 26Y) are installed in parallel attachably/detachably in forward and backward directions. In the embodiment, the front side of the printer 1 is a near side in an installing direction of the ink container 26 to the container installed part 8. The rear side of the printer 1 is a far side in the installing direction of the ink container 26 to the container installed part 8. The four ink containers 26 are provided for each ink color to contain respective inks of black (K), cyan (C), magenta (M) and yellow (Y) from an upstream side (a right side in the embodiment) in order of the conveying direction of the sheet P. In FIG. 3, the ink container 26K corresponding to the black (K) is installed to the container installed part 8. Hereinafter, except for the description to be specified by the colors, the reference characters “K”, “C”, “M” and “Y” with regard to the ink containers 26 are omitted.

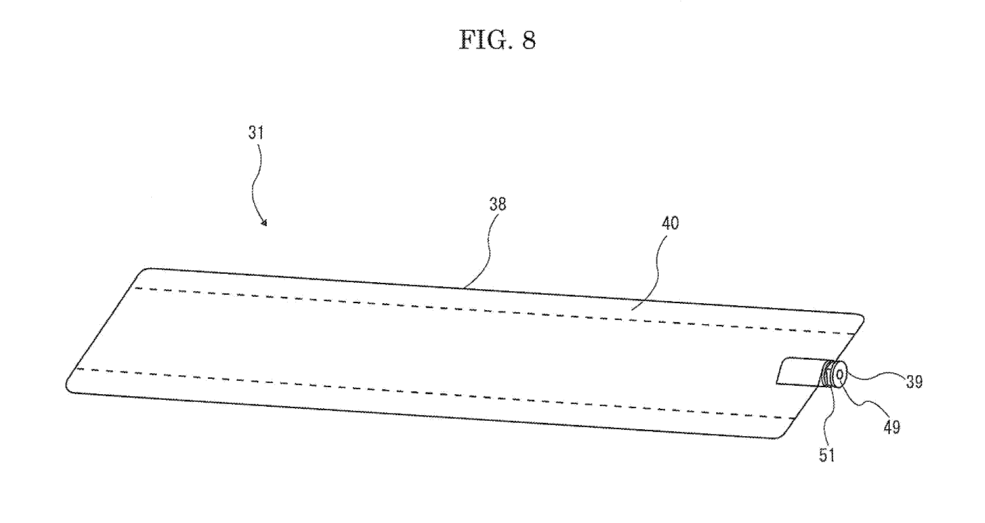

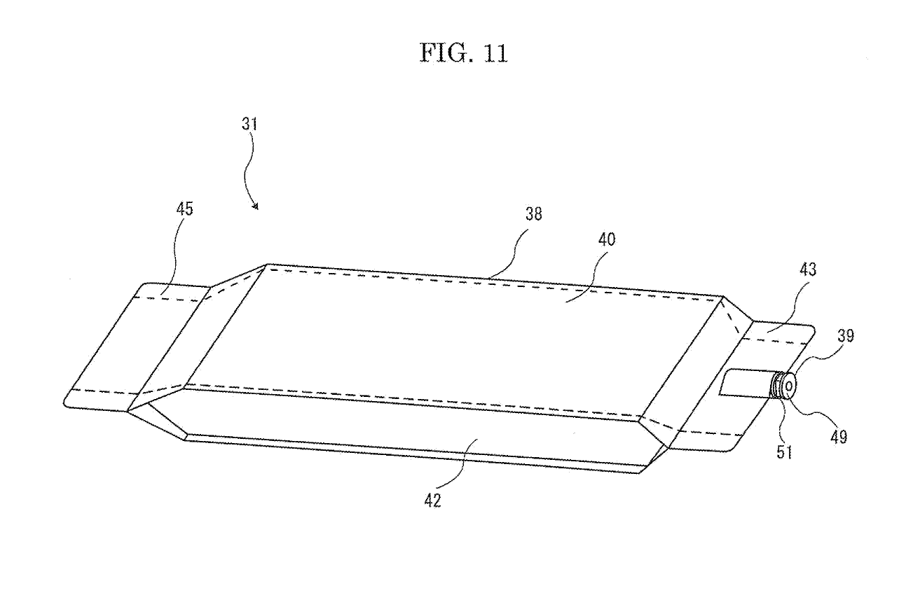

In the far side in the container installed part 8, hollow needles (not shown) connected to the ink supplying paths to the recording heads 25 are provided. The needle is configured to connect to a spout (a supplying member) 39 of an ink pack (a liquid container) 31 in the container 32 of the ink container 26 (refer to FIGS. 8 and 11 and other figures).

In a left upper part of the printer main body 2, an ejecting mechanism 27 is arranged. The ejecting mechanism 27 includes a drying device 28, an ejecting path and ejecting rollers 30. The drying device 28 is located at the left upper side of the conveying unit 14. The ejecting path 29 is arranged at the left side of the drying device 28 to extend upward to the protrusion 4 of the printer main body 2. The ejecting rollers 30 are located at a downstream end of the ejecting path 29 and in the vicinity of the ejecting port 5 inside the protrusion 4.

Next, the operation of forming an image by the printer 1 having such a configuration will be described.

In the printer 1, when image data is received from an external computer or the like, the sheet P stored in the sheet feeding cartridge 3 is fed to the conveying path 10 by the sheet feeding roller 11. The sheet P fed to the conveying path 10 is conveyed to a downstream side of the conveying path 10 by the conveying rollers 12, temporarily stopped by the resist rollers 13 so that printing timing is adjusted, and then, fed from the conveying path 10 to the conveyance face 21 of the conveyance belt 19. The sheet P fed to the conveyance face 21 of the conveyance belt 19 is absorbed to the conveyance face 21 of the conveyance belt 19 by suction force of the suction device (not shown) connected with the air intake duct 20.

On the other hand, to each recording head 25, the ink is supplied from each ink container 26. Each recording head 25 ejects the ink to the absorbed sheet P on the conveyance face 21 on the basis of the information of the image data received from the external computer or the like. Thereby, a color ink image is formed on the sheet P. The sheet P having the color ink image is advanced so that the ink on the surface is dried by the drying device 28, and then, passed through the ejecting path 29, and moreover, ejected on the ejected sheet tray 6 via the ejecting port 5 by the ejecting rollers 30.

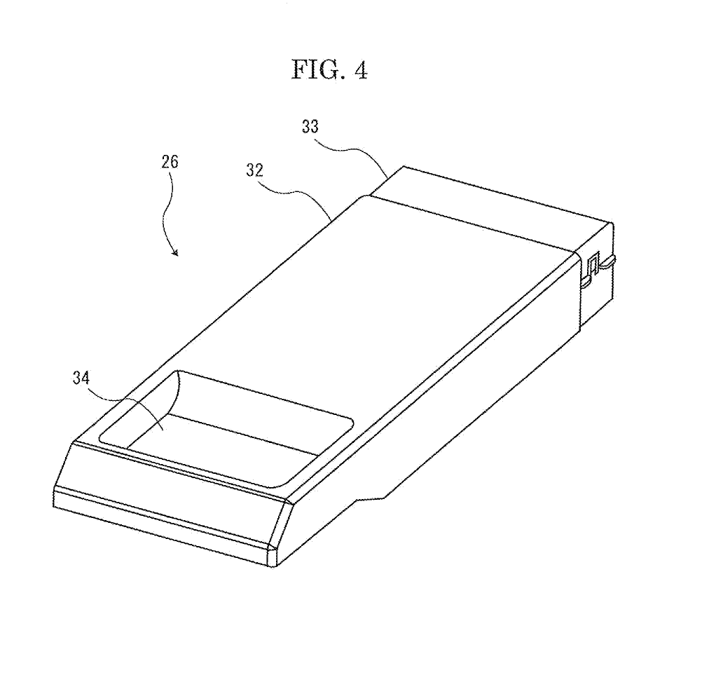

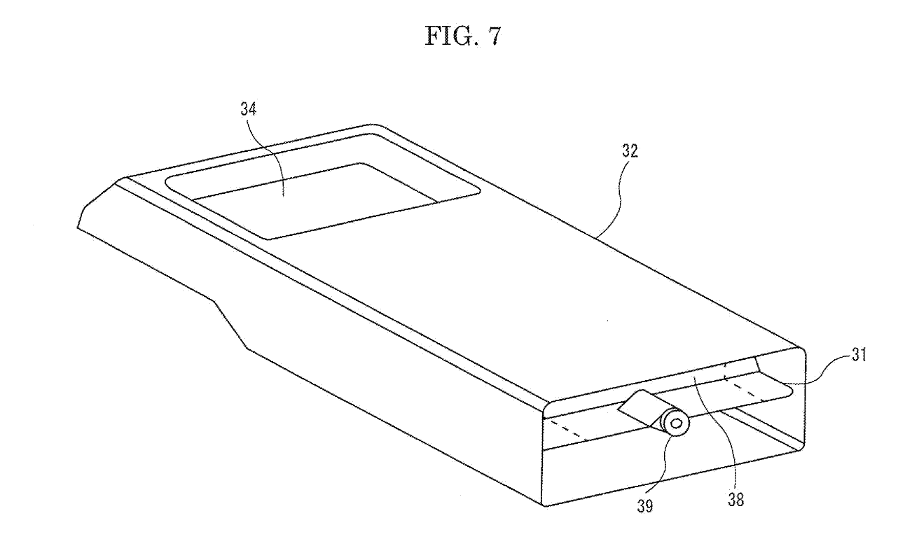

Next, with reference to FIGS. 4 to 7, the ink container 26 and ink pack 31 will be described in detail.

The ink container 26 is configured to contain the ink pack 31 elongated in forward and backward directions. The ink container 26 has a larger length in the forward and backward directions than the ink pack 31 in a state where the ink is used up, i.e., in a contracted state in upward and downward directions. In addition, the ink container 26 has a larger width in left and right directions than the ink pack 31 and has a larger height in the upward and downward directions the ink pack 31 in a state where the ink is filled, i.e., in a contracted state. That is, the ink container 26 has a capacity capable of containing the ink pack 31 in any state of the contracted state and contracted state.

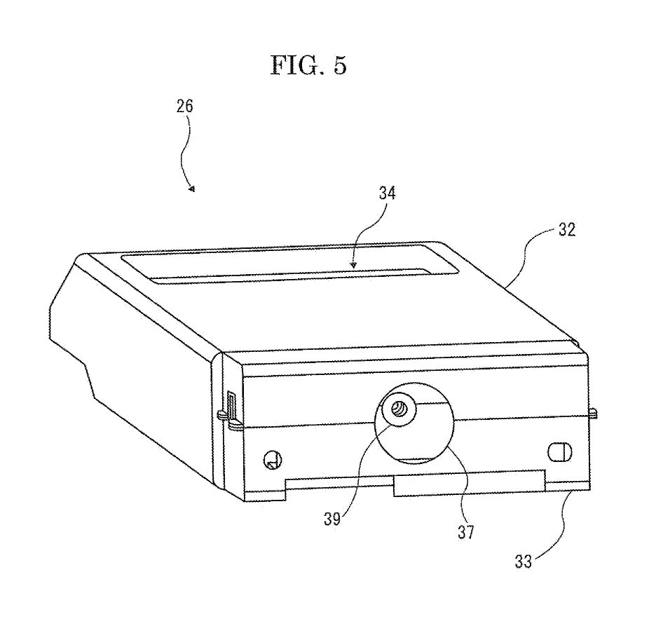

As shown in FIGS. 4 and 5 and other figures, the ink container 26 is provided with the roughly box-shaped container 32 elongated in the forward and backward directions and a spout cover 33 attached to a rear part of the container 32. In the ink container 26, the ink pack 31 is contained in the container 32 with a leading end to a rear side, i.e. backwardly.

In a front part of the container 32, as shown in FIGS. 4, 5 and 7, a grasping part 24 is provided. The container 32 is a hollow container having an opened back end and can contain the ink pack 31 from an opening formed in the back end. The rear end of the container 32 is formed into a shape to which an insertion part 35 of the spout cover 33 can be fitted. On an inner peripheral face at a rear part of the container 32, an engaging groove (not shown) is formed to engage with an engaging pawl 36 provided in the insertion part 35 of the spout cover 33.

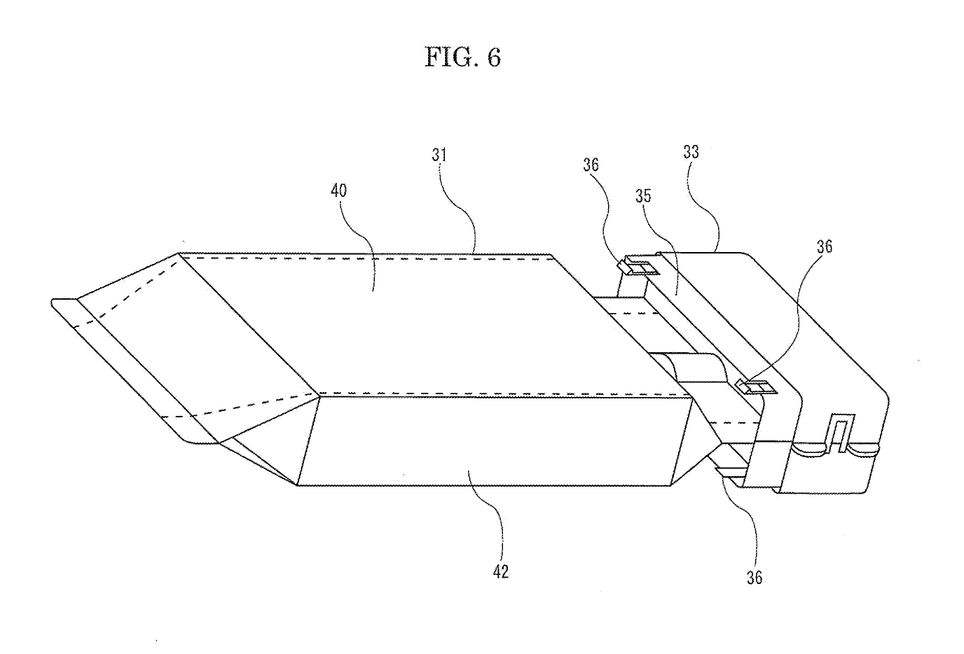

As shown in FIGS. 4 and 5, the spout cover 33 is formed into a rectangular parallelopiped shape having the height flush with the container 32 in front view, and has an opened front end. At the center of a rear end face of the spout cover 33, a circle-formed needle inlet port 45 is opened. As shown in FIG. 6, at the front part of the spout cover 33, the insertion part 35 fitted to the container 32 is formed. An outer periphery of the insertion part 35 is smaller than an outer periphery of the container 32, and has nearly the same diameter as the diameter of an inner periphery of the container 32. In the front end of the insertion part 35, the engaging pawl engaging with an engaging groove (not shown) in an inner peripheral surface of the container 32 is formed. Inside the spout cover 33, a fixing mechanism (not shown) is provided to fix a leading end of the ink pack 31 including the spout 39 at a center position in the upward and downward directions.

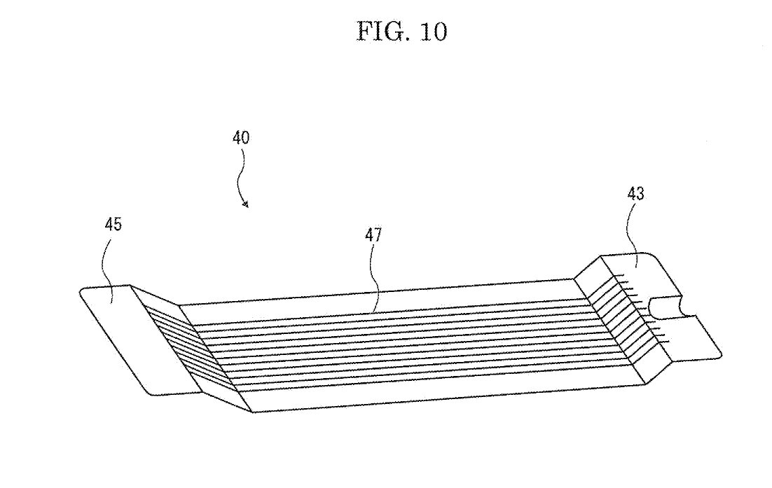

Next, with reference to FIGS. 8 to 11, the ink pack 31 will be described in detail.

As shown in FIGS. 8, 9 and 11, the ink pack 31 includes a pack main body (container main body) 38 formed into a gusset type bag shape elongated in the forward and backward directions, and the spout 39 partially embedded in a leading end of the pack main body 38. The ink pack 31 is configured so as to fill the ink in the pack main body 38 in a vacuum state, and to eject the ink in the pack main body 38 via the spout 39 by conducting the spout 39.

The pack main body 38 is made of a pliable (flexible) film material. The film material is made by laminating two material layers or more, such as resin and aluminium. As one example, polyester (PET), aluminium (AL), nylon (PA), and low level density polyethylene (LLDPE) are laminated in order from the surface side. Making a surface layer of the pack main body 38 from the polyester enables an external appearance and the strength of the ink pack 31 to be improved. Forming an aluminium layer in the pack main body 38 enables gas barrier of the ink pack 31 to be improved, thereby enhancing storability of the ink. Put differently, in the present embodiment, aluminium is used as a gas barrier material. Forming a nylon layer in the pack main body 38 enables the mechanical strength and shock resistance of the ink pack 31 to be improved. Making a back face layer, i.e., a most inside layer, from the low level density polyethylene enables the welding strength of the pack main body to be heightened in forming the film material into a bag shape by welding, thereby improving sealing quality. The most inside layer of the pack main body 38 has, for example, a thickness of 50 μm or more and 200 μm or less. The most inside layer of the pack main body 38 may be formed polypropylene instead of polyethylene.

The pack main body 38 is formed, for example, in a bag shape so that, between a upper face film (an upper face part) 40 and a lower face film (a lower face part) 41 formed in flat plate shapes, a pair of side films (gusset parts) 42 having respective gussets are provided at the both sides. Between leading end edges of the upper face film 40 and the lower face film 41, the spout 39 is provided at the center. Each side film 42 is folded back along a center line A (a folding line) in the left and right directions and internal surfaces facing to each other in the side film 42 are welded at the leading end edge and a base end edge. Each side film 42 is formed so as to expand and contract in the upward and downward directions.

Both side edges of the upper face film 40 and the lower face film 40 are respectively welded to the pair of side films 42. In addition, an upper face leading end 43 of the upper face film 40 and a lower face leading end 44 of the lower face film 41 are welded to each other together with the spout 39. Moreover, an upper face base end 45 of the upper face film 40 and a lower face base end 46 of the lower face film 41 are welded to each other. Thus, liquid tightness of the pack main body 38 is ensured. The upper face base end 45 and lower face base end 46 are welded as a whole, while the upper face leading end 43 and lower face leading end 44 are welded at a U-shaped range except for a portion at an inside space side of the pack main body 38. Such a non-welded area of upper face leading end 43 and lower face leading end 44 is an area keeping conduction of the inside space of the pack main body 38 and spout 39.

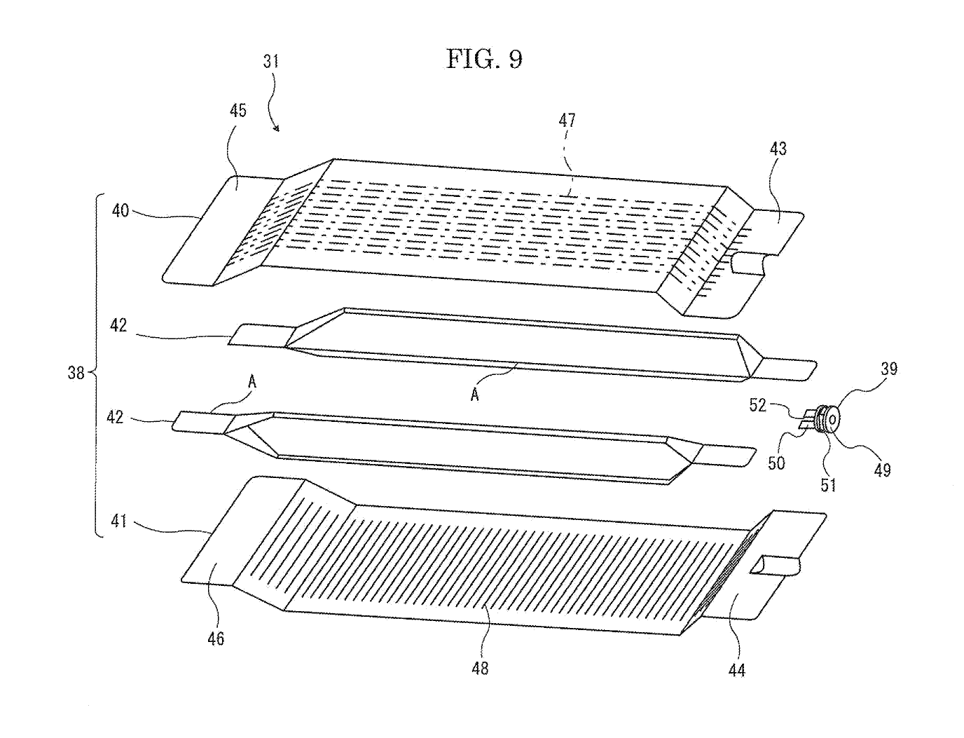

On an inner face of the upper face film 40, a plurality of upper face groove parts (first groove parts) 47 are formed to extend from a base end side (other end side) to a leading end side (one end side) in parallel with the folding line A of the side face film 42 (refer to FIG. 9). The plurality of the upper face groove parts 47 are arranged at a portion expect for the welding parts of the upper face film 40 with the lower face film 41 and side face films 42, and extended just before an attaching part of the spout 39. The plurality of the upper face groove parts 47 are formed on the most inside face layer of the pack main body 38. The upper face groove part 47 has preferably a depth of 40% or more and 60% or less of the most inside face layer, for example, a depth of 20 μm or more and 100 μm or less. The plurality of the upper face groove parts 47 are arranged, for example, at intervals of 5 mm or more and 20 mm or less on the inner face of the upper face film 40 and have respective widths of 0.5 mm or more and 2.0 mm or less.

On an inner face of the lower face film 41, a plurality of lower face groove parts (second groove parts) 48 are formed to extend in an orthogonal direction to the extending direction of the upper face groove parts 47 and to be orthogonal to the folding line A of the side face film 42. The plurality of the lower face groove parts 48 are arranged at a portion expect for the welding parts of the lower face film 41 with the upper face film 40 and side face films 42. The plurality of the lower face groove parts 48 are formed on the most inside face layer of the pack main body 38. The lower face groove part 48 has preferably a depth of 40% or more and 60% or less of the most inside face layer, for example, a depth of 20 μm or more and 100 μm or less. The plurality of the lower face groove parts 48 are arranged, for example, at intervals of 10 mm or more and 30 mm or less on the inner face of the lower face film 41 and have respective widths of 0.1 mm or more and 1.0 mm or less.

The plurality of the upper face groove parts 47 and the plurality of the lower face groove parts 48 are made, for example, by press work or grooving work using rollers having a plurality of rotating bodies formed in an abacus bead like shape and arranged in parallel.

In the pack main body 38, when the inside is expanded, for example, when the ink pack 31 is filled with the ink, the folding of the pair of the side face films 42 is stretched so that each side face film 42 is stood up, and accordingly, the upper face film 40 and lower face film 41 are separated. At this time, respective front parts and respective rear parts of the upper face film 40 and lower face film 41 are inclined, and then, the length of the pack main body 38, i.e., the length of the ink pack 31, is shorten. By contrast, in the pack main body 38, when the inside is contracted, for example, when the ink is ejected from the ink pack 31, the pair of the side face films 42 are folded along the folding line, and accordingly, the upper face film 40 and lower face film 41 come close to each other. Thus, the length of the pack main body 38, i.e., the length of the ink pack 31, is lengthened. Incidentally, since the upper face film 40 and lower face film 41, and the pair of the side face films 42 have flexibility, they may be folded regardless the folding line A shown in FIG. 9. However, because the folding line A is provided in advance, the pack main body can be proactively folded in accordance with the reduction of the ink so as to lengthen in the forward and backward directions.

The spout 49 has a supply port 49 exposed from the ink pack 31, and a connecting port 50 sealed between the upper face leading end 43 and lower face leading end 44.

The supply port 49 is formed into a cylindrical shape and has a seal part (not shown) sealing the inside to prevent leakage of the ink filled in the ink pack 31. Moreover, the supply port 49 has a groove 51 formed along an outer periphery to ensure fixing of the spout 39 to the spout cover 33 by engaging the groove 51 with the spout cover 33. The seal part of the supply port 49 is configured to be penetrate and passed through by a hollow needle (not shown) provided at the far side of the container installed part 8, when the container 32 containing the ink pack 31 is attached to the container installed part 8. The seal part closely contacts to an outer peripheral surface of the needle to prevent leakage of the ink, when the seal part is penetrate by the needle.

The connecting port 50 is formed into a hollow flat plate shape communicating with the supply port 49, and has a notch 52 at the rear end. The connecting port 50 is arranged at the non-welded area between upper face leading end 43 and lower face leading end 44. The notch enables the supply port 49 to communicate with the inside of the pack main body 38, even when the connecting port 50 is got caught between the upper face film 40 and lower face film 41.

That is, the spout 39 is conducted by penetration of the needle of the container installed part 8 to the seal part of the supply port 49. The pack main body 38 and the recording head 25 are communicated with each other through the spout 39 and needle, thereby allowing the ink in the pack main body 38 to be supplied to the recording head 25.

In the present embodiment, as mentioned above, the ink pack 31 has the plurality of the upper face groove parts 47 extending from the base end side to the leading end side on the inner face of the upper face film 40 are provided. Therefore, even when the ink pack 31 is shorten in the upward and downward directions by the ejection of the ink in the ink pack 31 and the upper face film 40 and lower face film 41 come close to each other, the conduction in the inside space of the ink pack 31 from the base end side to the leading end side is kept by the plurality of the upper face groove parts 47. Thus, it is possible to prevent a closing of the inside space in the ink pack 31 from causing by the close contact of the upper face film 40 and lower face film 41 and to easily supply the ink in the ink pack 31 to the spout 39. In this ink pack 31, particularly, when, at the spout 39's side, i.e., at the leading end side, in which the ejection of the ink and the closing are easily carried out, the upper face film 40 and lower face film 41 come close to each other, the inside space at the leading end side is not closed, and then, the ink at the base end side can be flowed to the spout 39 by passing through the plurality of the upper face groove parts 47. Accordingly, the amount of the not-ejected and remained ink in the ink pack 31 is reduced, and then, the ink pack 31 can be used until the ink is used up. That is, according to the disclosure, it is possible to easily supply the liquid in the ink pack 31 to the supply port 49 and reduce the amount of the liquid remained in the ink pack 31.

According to the present embodiment, the upper face groove parts 47 of the upper face film 40 are formed in parallel with the folding line A of the side face films 42. Therefore, since the liquid in the ink pack 31 can be smoothly flowed, it is possible to easily supply the liquid from the other end side to the one end side along the upper face groove parts 47.

In addition, according to the present embodiment, the ink pack 31 has the plurality of the lower face groove parts 48 extending in the orthogonal direction to the extending direction of the upper face groove parts 47 on the inner face of the lower face film 41. Therefore, if foreign matter gets mixed in the ink pack 31 by mistake, such a foreign matter is inserted or caught by the lower face groove parts 48 in outflow of the ink. Thus, it is possible to prevent the ink mixed with the foreign matter from ejecting.

Moreover, according to the present embodiment, the pack main body 38 of the ink pack 31 has laminating structure with two layers or more made of a plurality of materials and the plurality of the upper face groove parts 47 are provided on the most inside face layer. Therefore, it is possible to maintain the flexibility of the pack main body 38 and to suitably secure gas barrier and strength of the pack main body 38, and furthermore, to easily supply the liquid in the ink pack 31.

Although, in the present embodiment, a configuration of arranging the plurality of the upper face groove parts 47 extending from the base end side to the leading end side on the inner face of the upper face film 40 in parallel with the folding line A of the side face films 42 is described as a conduction part conducting from the base end side to the leading end side in the ink pack 31, the conduction part is not restricted by this configuration. In another embodiment, the conduction part may be arranged at least any one of the upper face film 40 and lower face film 41. For example, the conduction part conducting from the base end side to the leading end side in the ink pack 31 may be configured so that the plurality of the lower face groove parts 48 extending from the base end side to the leading end side on the inner face of the lower face film 41 are arranged in parallel with the folding line A of the side face films 42. Alternatively, the conduction part may be configured so that the plurality of the upper face groove parts 47 and the plurality of the lower face groove parts 48 are arranged so as to conduct from the base end side to the leading end side on both the inner faces of the upper face film 40 and lower face film 41.

Although, in the present embodiment, a configuration of arranging the plurality of the upper face groove parts 47 or the plurality of the lower face groove parts 48 in parallel with the folding line A of the side face films 42 is described as the conduction part conducting from the base end side to the leading end side in the ink pack 31, the conduction part is not restricted by this configuration. For example, the plurality of the upper face groove parts 47 or the plurality of the lower face groove parts 48 as the conduction part may be configured so as to extend from the base end side to the leading end side in the ink pack 31 and to converge on the center in the left and right directions, i.e., on the spout 39, at the leading end side. Therefore, it is possible to guide the ink supplied along the plurality of the upper face groove parts 47 or the plurality of the lower face groove parts 48 to the spout 39, and then, to facilitate the ejection of the ink.

In the present embodiment, configurations of welding the upper face leading end 43 of the upper face film 40 and the lower face leading end 44 of the lower face film 41 in the ink pack 31 at a range except for a portion at an inside space side of the pack main body 38 and of arranging the connecting port 50 of the spout 39 at the non-welded area of the upper face leading end 43 and lower face leading end 44 is described. However, the welding and arranging are not restricted by the configurations. For example, the upper face leading end 43 and lower face leading end 44 in the ink pack 31 may be welded as a whole and the connecting port 50 of the spout 39 may be arranged so as to insert in the inside space of the pack main body 38.

Although, in the present embodiment, a configuration of arranging the plurality of the lower face groove parts 48 extending in the orthogonal direction to the extending direction of the upper face groove parts 47 on the inner face of the lower face film 41 is described as a foreign matter ejecting prevention part, the foreign matter ejecting prevention part is not restricted by this configuration. For example, in another embodiment, the plurality of the lower face groove parts 48 may be formed in any shape, such as a wave groove, extending in a direction crossing to the extending direction of the upper face groove parts 47.

Although as the embodiment, configurations of the disclosure are applied to the printer 1 as the inkjet image forming apparatus, as a different embodiment, the ideas of the disclosure may be applied to a different inkjet image forming apparatus, such as a copying machine, a facsimile or a multifunction machine.

While the present disclosure has been described with reference to the particular illustrative embodiments, it is not to be restricted by the embodiments. It is to be appreciated that those skilled in the art can change or modify the embodiments without departing from the scope and spirit of the present disclosure.

What is claimed is:

1. A liquid container comprising:
a container main body formed in a bag shape by arranging a gusset part expandably/contractably in upward and downward directions between an upper face part and a lower face part; and
a supplying member arranged at one end side of the upper face part and lower face part,
wherein, on at least any one of inner faces of the upper face part and lower face part, a first groove part is formed to extend from another end side at an opposite side of the one end side to the one end side.

2. The liquid container according to claim 1, wherein the gusset part has a folding line, and
the first groove part is arranged in parallel with the folding line.

3. The liquid container according to claim 1, wherein the first groove part is arranged so as to extend from the other end side to the one end side and to converge on the supplying member.

4. The liquid container according to claim 1, wherein the first groove part is arranged on the inner face of the upper face part, and
on the inner face of the lower face part, a second groove part is arranged to extend in a direction crossing to the first groove part.

5. The liquid container according to claim 1, wherein the container main body has laminating structure with two layers or more made of a plurality of materials,
the most inside face layer of the laminating structure has a thickness of 50 μm or more and 200 μm or less, and
the first groove part has a depth of 40% or more and 60% or less of the thickness of the most inside face layer.

6. An inkjet image forming apparatus comprising:
a liquid container, wherein the liquid container includes:
a container main body formed in a bag shape by arranging a gusset part expandably/contractably in upward and downward directions between an upper face part and a lower face part; and
a supplying member arranged at one end side of the upper face part and lower face part,
wherein, on at least any one of inner faces of the upper face part and lower face part, a first groove part is formed to extend from another end side at an opposite side of the one end side to the one end side.

7. The inkjet image forming apparatus according to claim 6, wherein the gusset part has a folding line, and
the first groove part is arranged in parallel with the folding line.

8. The inkjet image forming apparatus according to claim 6, wherein the first groove part is arranged so as to extend from the other end side to the one end side and to converge on the supplying member.

9. The inkjet image forming apparatus according to claim 6, wherein the first groove part is arranged on the inner face of the upper face part, and
on the inner face of the lower face part, a second groove part is arranged to extend in a direction crossing to the first groove part.

10. The inkjet image forming apparatus according to claim 6, wherein the container main body has laminating structure with two layers or more made of a plurality of materials,
the most inside face layer of the laminating structure has a thickness of 50 μm or more and 200 μm or less, and
the first groove part has a depth of 40% or more and 60% or less of the thickness of the most inside face layer.
